(19) United States
(12) Patent Application Publication
(10) Pub. No.: US 2020/0020197 A1
(43) Pub. Date: Jan. 16, 2020

(54) SYSTEM AND METHOD FOR INTELLIGENTLY REWARDING GAME MISSION ACCOMPLISHMENT

(71) Applicant: Motion Device Inc., Anyang-si (KR)

(72) Inventor: Jong Chan LEE, Anyang-si (KR)

(21) Appl. No.: 16/221,898

(22) Filed: Dec. 17, 2018

(30) Foreign Application Priority Data
Jul. 12, 2018 (KR) 10-2018-0080916

(51) Int. Cl. G07F 17/32

(52) U.S. Cl. CPC G07F 17/3239; G07F 17/3223; G07F 17/3244

(57) ABSTRACT

The present disclosure provides a system and method for intelligently rewarding a game mission accomplishment in a gaming store in which at least one game machine is installed. The system includes a mission and reward setting unit configured to set a mission and a reward to be presented to a user using the game machine. The system also includes a user identifying unit configured to identify the user boarding the game machine and a data collecting unit configured to collect game execution data of the user identified by user identifying unit. The system also includes a data analyzing unit configured to analyze the game execution data collected from the game machine to determine whether the user succeeded in the mission accomplishment. The system further includes a rewarding unit configured to provide the reward set by the mission and reward setting unit when the user succeeded in the mission accomplishment.

### CROSS-REFERENCE TO RELATED APPLICATION

The present application claims priority to Korean Patent Application No. 10-2018-0080916, filed on Jul. 12, 2018, in the Korean Intellectual Property Office, which is incorporated herein in its entirety by reference.

### BACKGROUND

### Technical Field

The present disclosure relates to a method of supporting an operation of a gaming room or gaming store in which a plurality of game machines are installed and, more particularly, to a method of intelligently assigning a mission to be accomplished during the use of the plurality of game machines and effectively rewarding for an accomplishment of the mission.

### Related Technology

A motion simulator is an apparatus that reproduces a dynamic movement in a virtual environment controlled by a computer so that a user can recognize the movement in the virtual reality as a real phenomenon. The motion simulator typically includes a simulation screen, an operation lever, and a chair movable in two or three dimensions in a state that the user is seated. The motion simulator may further include configurations for motions of the chair such as a linear movement and a rotation. For example, the motions in the motion simulator may include the linear movement in a forward and backward direction (z-axis), a lateral direction (x-axis), or a vertical direction (y-axis), a rolling that is the rotation around the z-axis, a pitching that is the rotation around the x-axis, or a yawing that is the rotation around the y-axis, and a combination thereof. Accordingly, when a user manipulates the operation lever in the motion simulator, the chair can move according to the manipulation of the user, so that the immersion of the user participating in the simulation using the motion simulator may be enhanced.

Owing to these operational features, the motion simulator is being used for a flight simulation and a driving simulation as well as for a game and a cinematic simulator to provide three-dimensional special effects. One example of such a motion simulator is disclosed in Korean unexamined patent publication No. 10-2004-0048584 entitled MOTION SIMULATOR FOR EXPERIENCING ASSUME ACTUALITY AND CONTROL METHOD THEREFOR.

In particular, increasing recently are places of business in which the motion simulators are installed to allow users to enjoy virtual reality games using the motion simulators with fees. The virtual reality games available in such gaming rooms or gaming stores include, for example, a virtual reality biking, a virtual reality roller coaster, a virtual reality shooting game, a virtual reality racing game. However, just a few of the virtual reality games are being used by game users while most of the games are not being actively used by the users because of failures in appealing to user preferences or indifferences of the users. Accordingly, the market of the virtual reality games is not boosted yet.

### SUMMARY

Provided are a system and method of intelligently rewarding for mission accomplishment, which supports an assignment of a mission, to a game user, to be accomplished by use of a plurality of game machines installed in a gaming room or gaming store and rewarding for an accomplishment of the mission so as to increase the use of the plurality of game machines.

In particular, the present disclosure provides a system and method of intelligently rewarding for mission accomplishment, in which game performance data of the game user for the plurality of game machines is analyzed by using an artificial intelligence-based learning algorithm to choose an appropriate mission and rewarding for the game user.

According to an aspect of an exemplary embodiment, provided is a system for intelligently rewarding for a mission accomplishment in a gaming store in which at least one game machine is installed. The system includes: a mission and reward setting unit configured to set a mission and a reward to be presented to a user using the game machine; a user identifying unit configured to identify the user boarding the game machine; a data collecting unit configured to collect game execution data of the user identified by user identifying unit; a data analyzing unit configured to analyze the game execution data collected from the game machine to determine whether the user succeeded in the mission accomplishment; and a rewarding unit configured to provide the reward set by the mission and reward setting unit when the user succeeded in the mission accomplishment.

The data analyzing unit may analyze past game execution data of the user and extract advice information related to the mission accomplishment to provide to the user.

The mission may be set as a mission item and a target value for the mission item. The mission item may include at least one of: a reaction point that measures a response of the user during a play of a game, a game score obtained according to a fulfillment of the game, and a game lap time. The reaction point may be calculated according to at least one of a facial analysis result or a motion analysis result based on images captured by a camera, and a voice analysis result for the voice of the user acquired by an audio device while the user is playing in the game machine corresponding to the game.

The mission and reward setting unit may set the mission and the reward for each of the at least one game machine, for each item, or for a combination of two or more game machines.

The data analyzing unit may analyze at least one of a tendency, a preference, and a capability of the user based on past game execution data of the user. The mission and reward setting unit may set the mission and the reward for the mission accomplishment for each user based on an analysis result of the data analyzing unit.

The user identifying unit may recognize a short-range terminal device held by the user by use of a short-range communication reader mounted in the game machine and identify the user by matching unique identification information of the short-range terminal device with identification information of a mobile terminal device of the user.

The rewarding unit may transmit rewarding information corresponding to the mission accomplishment to a mobile terminal device of the identified user.

According to an aspect of another exemplary embodiment, provided is a method of intelligently rewarding for a mission accomplishment in a gaming store in which at least one game machine is installed. The method is performed by a computing apparatus connected to the at least one game machine. The method includes: setting a mission and a reward to be presented to a user using the game machine; identifying the user boarding the game machine; collecting game execution data of the user identified by user identifying unit; analyzing the game execution data collected from the game machine to determine whether the user succeeded in the mission accomplishment; and providing the reward set for the mission accomplishment when the user succeeded in the mission accomplishment.

The method may further include an operation of transmitting information on the mission and the reward for the mission accomplishment, in advance, to a mobile terminal device of the user of which terminal is registered being matched with a short-range communication terminal of an identified user or to a mobile terminal device of a subscribed user.

The operation of setting the mission and the reward may include: analyzing at least one of a tendency, a preference, and a capability of the user based on past game execution data of the user; and setting the mission and the reward for the mission accomplishment for each user based on an analysis result of the tendency, the preference, and the capability of the user

The present disclosure supports an operation of a gaming room or gaming store in which at least one game machine such as a virtual reality game is installed by assigning a mission to be accomplished by a gamer and rewarding for an accomplishment of the mission, and thus may enhance the use of the game machine and allow the owner of the gaming room to operate the gaming room efficiently.

In particular, the present disclosure identifies the user boarding the game machine by a short-range wireless communication such as a Near Field Communication (NFC) and a Bluetooth Low Energy (BLE) communication with a terminal device held or worn by the user and having a shape of a card or a wearable device and collects and analyzes game performance data of the user to determine whether the user accomplished the mission and is to be rewarded. The present disclosure stores the identification information acquired from the terminal device of the user along with the identification information of the mobile terminal of the user to notify rewarding information to the mobile terminal of the user.

In addition, the present disclosure analyzes past game execution data of the user to provide advisory information related to the accomplishment of the mission, thereby attracting the concern and interest of the user and enhancing the use of the game machine.

### BRIEF DESCRIPTION OF THE DRAWINGS

In order that the disclosure may be well understood, there will now be described various forms thereof, given by way of example, reference being made to the accompanying drawings.

FIG. 1 is a functional block diagram of an intelligent rewarding system according an embodiment of the present disclosure.

FIG. 2 is a schematic illustration of an exemplary implementation of the intelligent rewarding system according an embodiment of the present disclosure.

FIG. 3 is a block diagram of an exemplary game machine according to an embodiment of the present disclosure.

FIG. 4 is a flowchart illustrating a process of intelligently rewarding for mission accomplishment according to an embodiment of the present disclosure.

The drawings described herein are for illustration purposes only and are not intended to limit the scope of the present disclosure in any way.

### DETAILED DESCRIPTION

Hereinbelow, exemplary embodiments of the present disclosure will be described in detail with reference to the accompanied drawings. In the following description and the accompanied drawings, detailed descriptions of well-known functions or configuration that may obscure the subject matter of the present disclosure will be omitted for simplicity. Also, in the drawings, the same reference numerals are used to designate the same or similar elements throughout the drawings.

The terms and words used in the following description including the appended claims are not necessarily to be construed in an ordinary sense or a dictionary meaning, and may be appropriately defined herein to be used as terms for describing the present disclosure in the best way possible. Such terms and words should be construed as meaning and concept consistent with the technical idea of the present disclosure. The embodiments described in this specification and the configurations shown in the drawings are merely preferred embodiments of the present disclosure and are not intended to limit the technical idea of the present disclosure. Therefore, it should be understood that there may exist various equivalents and modifications that may substitute the exemplary embodiments at the time of filing of the present application.

The terminologies including ordinal numbers such as “first” and “second” used to describe various elements in this specification may be used only to discriminate one element from another elements, but the terms do not restrict the structures of the elements. For example, a second component may be referred to as a first component, and similarly, a first component may also be referred to as a second component without departing from the scope of the present disclosure.

When an element is referred to as being “connected” or “coupled” to another element, it means that it is logically or physically connected or it may be connected to the other element. In other words, it is to be understood that although an element may be directly connected or coupled to another element, there may be other elements therebetween, or element may be indirectly connected or coupled to the other element.

The terminology used herein is chosen for the purpose of describing particular embodiments only and is not intended to be limiting of the disclosure. The singular forms include plural referents unless the context clearly dictates otherwise. Also, The expressions “˜comprises,” “˜includes,” “˜constructed,” “˜configured” are not to be construed as being equipped with all the components, processing steps, or operations described in this specification, but some of the components, the processing steps, or the operations may not be included and additional elements may be incorporated further.

The term “gaming store” is used herein to refer to a facility equipped with at least one game machine to allow the public to play games using the game machine. Game users may have to pay for the games in the gaming store. However, the present disclosure is not limited thereto, and the games may be provided free of charge to the game users. Meanwhile, the gaming store may be a space dedicated for the gaming. However, the store may be a space used mainly for other purposes while the gaming is allowed as a secondary service.

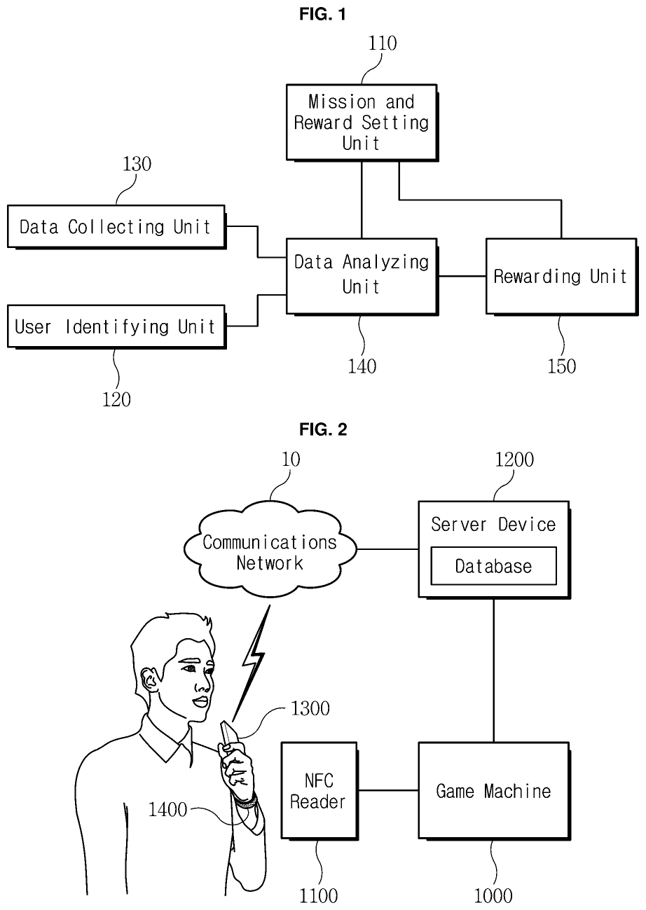

FIG. 1 is a functional block diagram of an intelligent rewarding system according an embodiment of the present disclosure.

The intelligent rewarding system according to the present disclosure supports an operation of a gaming room in which a plurality of game machines are installed by assigning a mission to be accomplished by a gamer and rewarding for an accomplishment of the mission. The game machines may be devices for the gamer to enjoy games based on virtual reality (VR). However, the present disclosure is not limited thereto, and the all or some of the game machines may be devices to which similar technologies as the VR, e.g. an augmented reality or a mixed reality, is applied. In the following description, the game machines are assumed to be VR simulator devices, for example. That is, each of the game machines may include a VR device, a manipulation device, and a boarding mechanism including a boarding chair and at least one actuator. In each of the game machines, as a game user is seated in the boarding chair and manipulates the manipulation device to execute a specific game, the at least one actuator can change the position and/or direction of the boarding chair as needed. The games that may be executed by the plurality of game machines may include at least one of virtual reality games, for example, a virtual reality pirate ship ride, a virtual reality roller coaster, a virtual reality shooting game, and a virtual reality sports game.

To assign a mission and a reward for the mission accomplishment to the game user, a system of the present disclosure includes a mission and reward setting unit 110, a user identifying unit 120, a data collecting unit 130, a data analyzing unit 140, and a rewarding unit 150.

For simplicity, FIG. 1 depicts just the components that are necessary for rewarding for the mission accomplishment according to the present disclosure. To support the operation of the components depicted in FIG. 1, the system of the present disclosure may further include an input device suitable for receiving an administrator's input, an output device suitable for outputting information to the administrator, a plurality of communication units suitable for establishing communication channels to the plurality of game machines and an external communication network, a storage device suitable for storing data and program codes to be executed, and other hardware or software components. Also, the functional elements depicted in FIG. 1 may be implemented by a combination of appropriate hardware and software components.

The function and operation of each of the functional elements depicted in FIG. 1 will now be described below.

The mission and reward setting unit 110 sets a mission to be assigned to the game user along with a reward for the mission accomplishment of the game user. In the present disclosure, the term “mission” refers to a specific behavior or a goal to be accomplished by the game user during the game. For example, the mission may be set as a mission item and a target value for the mission item The mission item may include at least one of: a reaction point that measures a response of the game user during the play of the game, a game score that may be obtained according to a fulfillment of the game, and a game lap time. Here, the reaction point may be calculated according to at least one of a facial analysis result or a motion analysis result based on images captured by a camera, and a voice analysis result for the voice of the game user acquired by an audio device while the game user is playing the game using the game machine.

The mission may be set for each of the game machines or be set as a combination of missions that may be accomplished in two or more game machines. For example, the mission may be set to be ‘acquiring a predetermined reaction point in a first game machine which is a VR game machine and breaking through four racing courses in a second game machine which is a racing game machine.’ The present disclosure may induce the game users to use various game machines by setting various missions in such a manner.

Also, the mission according to the present disclosure may be set adaptively to a current situation of the gaming room by analyzing game performance data of the game users for the plurality of game machines in the gaming room by use of an artificial intelligence (AI) learning algorithm or the like. For example, the mission may be set according to an analysis result for a usage history, a usage frequency, a user reaction, a user interest, a learning speed, and the like for each of the plurality of game machines.

For example, if the usage frequency of the first game machine is high but the usage frequency of the second game machine is low in the gaming room, the mission to be rewarded may be set to be a completion of both a task in the first game machine and a task in the second game machine. In another example, in case that the learning or the mission accomplishment of the game users for the first game machine is fast, a target value of the mission for the first game machine may be increased. Also, in case that the success ratio of the game users for the first game machine is high, the mission and reward setting unit 110 may determine that there are many game users who have experienced the first game machine, and cancel the task associated with the first game machine and add a new task related to another game machine exhibiting a low success ratio.

The reward for the mission accomplishment may be provided in various forms such as paying or discounting at least some of the game fee, providing a prize, accumulating a predetermined point such as membership point. For example, a game user who played the first game may be rewarded by a game coupon depending on whether the game user accomplished the mission for the first game machine, so that the game user may use the first game machine again or another game machine by use of the coupon.

After the mission and the reward for the mission accomplishment are set, the mission and reward setting unit 110 may transmit information about the mission and the reward to mobile terminal devices of members who are registered to the system. In another embodiment, the mission and reward setting unit 110 may transmit the information about the mission and the reward to a mobile terminal device of the game user identified by the user identifying unit 120 before a start of the game of the game user. By providing the information about the mission and the reward in advance to potential game users, the system enables the potential game users to recognize the mission and the reward and induces the concern and interest in the mission of the potential game users.

The user identifying unit 120 recognizes the game user who have boarded each of the game machines. The user identifying unit 120 may identify the game user by recognizing unique identification information of each game user. The unique identification information of each game user may be recorded in a recording medium such as a Near Field Communication (NFC) card, a wearable device (e.g. a smart band), and a radio frequency identification (RFID) tag. The user identifying unit 120 may recognize the unique identification information of the game user by a short-range wireless communication such as a Near Field Communication (NFC) and a Bluetooth Low Energy (BLE) communication or a contact-type or non-contact type recognition technology. In an exemplary embodiment of the present disclosure, the user identifying unit 120 may include an NFC reader. The NFC reader may be mounted on the game machine and recognize the NFC terminal device held by the game user. A detailed configuration of the NFC reader will be described below with reference to FIG. 2.

At this time, the user identifying unit 120 may recognize the game users by distinguishing each game user who visits the game machine 1000 to play a game at the game machine from others. Also, the user identifying unit 120 may recognize the identity of each game user based on personal information (e.g. mobile phone number) of the game user. To this end, the system may register the personal information of the game user by matching with user identification information that may be recognized by the user identifying unit 120. The personal information of the game user may be acquired through a member registration or subscription process.

The data collecting unit 130, which collects base data for use in setting the mission and rewarding for the mission accomplishment, collects game execution data from the plurality of game machines whenever a game user recognized by the user identifying unit 120 completes a game. The game performance data collected by the data collecting unit 130 may be stored in a database with the information of the game user and the game machine for each game execution data. The game performance data may include a game result that may be used for determining the mission accomplishment. In addition, the data collecting unit 130 may further collect store data, machine data, and user data. These data may be acquired from the game machine or be input by the store administrator.

The data analyzing unit 140 determines whether the game user accomplished the mission by analyzing the data collected by the data collecting unit 130, particularly, the game execution data of the game user for related with a determination of the mission accomplishment. The data analyzing unit 140 may extract a mission the game user succeeded in by comparing the data collected by the data collecting unit 130 with the mission set for the game machine or the store.

Also, the data analyzing unit 140 analyzes a past game history of the game user recognized by the user identifying unit 120 by use of past game execution data of the game user among the data collected and stored by the data collecting unit 130. The data analyzing unit 140 may extract advice information related to the mission accomplishment to provide to the game user. The advice information may include, for example, information on a mission accomplishment probability calculated based on a game execution capability of the game user estimated from past game execution data of the game user. The data analyzing unit 140 may provide the advice information to the mobile terminal device of the game user recognized by the user identifying unit 120.

Further, the data analyzing unit 140 may analyze game execution information of a plurality of game users for the plurality of game machines to generate advisory information regarding the setting of the mission and reward for the store and provide to the store administrator. Thus, the store administrator can set the mission and the reward based on the advisory information.

Here, the data analyzing unit 140 may analyze data using a learning algorithm of an artificial intelligence or other data analysis technique other than the artificial intelligence learning algorithm. Typical learning algorithms applicable for the data analysis may include a decision tree which is an analysis tool for classifying and predicting possible consequences by plotting decision rules in a tree-like structure, a Bayesian network which is a probabilistic graphical model that represents a set of variables and their conditional dependences via a directed acyclic graph, a support vector machine (SVM) which is a learning model with associated learning algorithms that analyze data used for classification and regression analysis, or an artificial neural network, that is an information processing system inspired by operations and connections of biological neurons, in which multiple neurons called nodes or processing elements are connected in a layered structure. Also, the data analyzing unit 140 may employ deep learning which is a technique used for clustering or classifying data using an artificial neural network. The artificial neural network in machine learning and cognitive science is a statistical learning algorithm inspired by a biological neural network (e.g. a central nervous system of an animal, especially the brain). The artificial neural network generally refers to a model in which artificial neurons forming a network by synapse connections can change synaptic bond strength through learning to solve problems. The core of the deep learning using the artificial neural network is a prediction through a classification. A computer classify data by finding patterns in a lot of data just like a human being discriminates objects.

Meanwhile, according to another embodiment of the present disclosure, the mission and the reward for the mission accomplishment may be may be provided in a customized manner. In detail, the data analyzing unit 140 may analyze at least one of: a tendency, a preference, and a capability of each game user based on past game execution data of the game user, and the mission and reward setting unit 110 may set the mission and the reward for the mission accomplishment for each game user based on personal characteristics data extracted by the data analyzing unit 140. If a customized mission is provided for each game user according to the personal characteristics data such as the tendency, the preference, and the capability of the game user in such a manner, or the user is allowed to set the mission and the reward for the mission accomplishment for oneself in consideration of the personal characteristics data, the concern and interest of the game user can be maximized. Also, owing to the mission and the reward for the mission accomplishment, the store administrator can perform various marketing efforts and maximize the usage of the game machines.

The rewarding unit 150 provides the reward set by the mission and reward setting unit 110 to the game user recognized by the user identifying unit 120 according to the determination result of the data analyzing unit 140, that is, whether the mission is accomplished or not. The rewarding unit 150 may transmit rewarding information to the mobile terminal of the game user.

As described above, the intelligent rewarding system according to the present disclosure allows to set the mission to be accomplished during the execution of the games and reward for the mission accomplishment correspondingly to the types and usage of the game machines installed in the store, and provides the game users with the advise information related with the mission accomplishment, so as to enhance the interest in participating in the mission of the game users and potential game users and improving the usage of the game machines and satisfaction of the game users with the games.

The mission and reward setting unit 110, the user identifying unit 120, the data collecting unit 130, the data analyzing unit 140, and the compensation unit 150 may be implemented by hardware, software, or a combination of them.

For example, the user identifying unit 120 may be implemented as a device independently installed in each of the game machines while the other components including the mission and reward setting unit 110, the data collecting unit 130, the data analyzing unit 140, and the rewarding unit 150 may be implemented as program modules that are installed and executed in a computer of a server system.

FIG. 2 is a schematic illustration of an exemplary implementation of the intelligent rewarding system according an embodiment of the present disclosure. In the following description, it is assumed that the game users are recognized based on the NFC technology. However, the present disclosure is not limited thereto, another technology selected from a variety of short-range wireless communication technologies such as the non-contact type or the non-contact type recognition technologies, Bluetooth, and RFID can be employed as well.

Referring to FIG. 2, the intelligent rewarding system according an embodiment of the present disclosure includes a plurality of game machines 1000, an NFC reader 1100 installed in each of the plurality of game machines 1000, a server device 1200, a mobile terminal device 1300, and an NFC terminal device 1400. Though a single game machine 1000 is depicted in FIG. 2 for simplicity, the present disclosure is not limited thereto and the system may include the plurality of game machines 1000 each of which is equipped with respective NFC reader 1100 and may be connected to the server device 1200 in parallel or in series through a local wired or wireless communications network.

Also, the server device 1200 may be connected to an external communications network 10 such as Internet to transmit data to the mobile terminal device 1300 of the user through the communications network 10. The communications network 10 may include at least one of a wired or wireless network and a mobile communications network. For example, in the case that the mobile terminal device 1300 is a mobile phone subscribed to a mobile communications service, the communications network 10 may be a combination of the Internet and the mobile communications network.

The store or gaming room according to an embodiment of the present disclosure may provide the game user with the NFC terminal device 1400 having a shape of a card or a wrist band and being embedded with an NFC chip to perform NFC function, so that the game user can use the game machine 1000 by use of the NFC terminal device 1400. Of course, the shape of the NFC terminal device 1400 is not limited to the card or the wrist band, but may be implemented in various forms.

The NFC terminal device 1400 has unique identification information so that the system can identify the game user by recognizing the NFC terminal device 1400. Meanwhile, the NFC terminal device 1400 may further store information on game usage such as a purchased amount, used amount, a balance, and a free pass or coupon.

Each game machine 1000 can recognize the NFC terminal device 1400 held or worn on the wrist by the game user through the NFC reader 1100, and recognizes the unique identification information stored in the NFC terminal device 1400 to identify the game user. In other words, the NFC reader 1100 works as a part of the user identifying unit 120 in the present embodiment.

When the identification of the game user on board in the game machine 1000 is completed through the NFC reader 1100, the game machine 1000 performs a gaming function, for example, a virtual reality pirate ship ride, a virtual reality roller coaster, a virtual reality shooting game, and a virtual reality racing game in accordance with an algorithm set in advance and in response to the manipulation of the game user. At this time, the game machine 1000 can generate the game execution data. The game execution data may include a game score that the game user reached during the execution of the game, a game execution time, and a reaction point extracted by analyzing a reaction of the user such as a detected movement or a recognized voice during the execution of the game. Also, the game execution data may include different types of information according to the type of the game machines. For example, in the case of an experiential game such as the virtual reality pirate ship ride or the virtual reality roller coaster, the game execution data may include a video image of the game user while the user is on board.

The game machine 1000 transmits the game execution data of the game user to the server device 1200 after the completion of the corresponding game or during the execution of the game. At this time, the game machine 1000 may transmit the unique identification information read out from the NFC terminal device 1400 of the recognized user along with the game execution data.

The server device 1200 implements the mission and reward setting unit 110, the data collecting unit 130, the data analyzing unit 140, and the rewarding unit 150 of the intelligent rewarding system according to the present disclosure. The server device 1200 is equipped with program modules suitable for performing the functions of the mission and reward setting unit 110, the data collecting unit 130, the data analyzing unit 140, and the rewarding unit 150.

The server device 1200 stores the game execution data received from the game machine 1000 into the database according to the identification information of the NFC terminal device 1400. Also, the server device 1200 recognizes each game user based on the identification information of the NFC terminal device 1400. At this time, the server device 1200 may acquire an identification information of the mobile terminal device 1300 of the user and register the identification information of the mobile terminal device 1300 matching the identification information identification information of the NFC terminal device 1400.

Meanwhile, the game machine 1000 can present various kinds of missions, depending on the game type, that may be performed by the game user. For example, in the case of the experiential game such as the virtual reality pirate ship ride or the virtual reality roller coaster, the mission may include at least one of: showing a specific reaction, checking the number of objects, or catching an object during the execution of the game. In case of a racing game, the mission may be breaking through a certain number of racing courses in a prescribed time or breaking through a certain course in a given time. In case of a fighting game, a certain degree of damage to the opponent may be set as a mission.

The mobile terminal device 1300, which is a device of a game user or a potential game user, may be a mobile device having communications capabilities such as a smart phone, a smart watch, and a tablet PC. The game user may receive mission-related information, through the mobile terminal device 1300, such as a mission to be presented in the future and a reward for the mission accomplishment, and a mission already accomplished by the user and a resultant reward.

The server device 1200 may be connected to the game machine 1000 and the mobile terminal device 1300 through a wired or wireless network. For example, the server device 1200 may be connected directly to the game machine 1000 by a communication cable, or may be connected through the wired network or a short-range wireless network. Also, the server device 1200 can communicate with the mobile terminal device 1300 through the short-range wireless channel or through a mobile communications network.

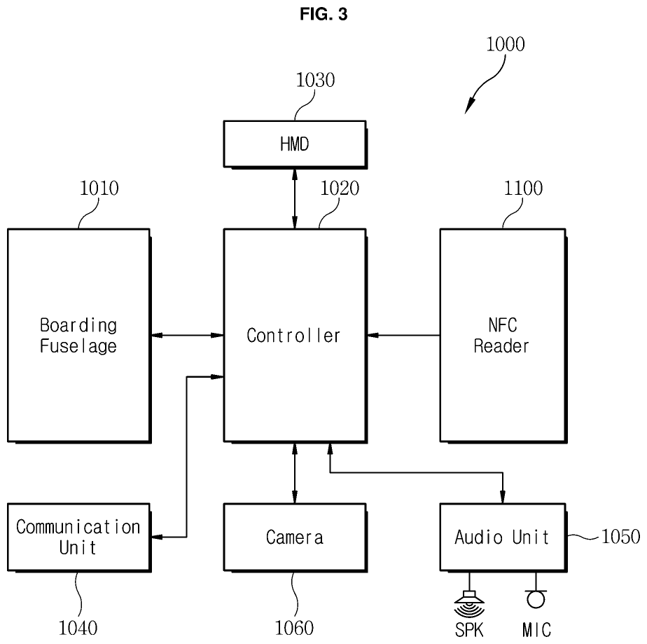

FIG. 3 is a block diagram of an exemplary game machine according to an embodiment of the present disclosure.

Referring to FIG. 3, the game machine 1000 includes a boarding fuselage 1010, a controller 1020, a head mounted display (HMD) unit 1030, a communication unit 1040, an audio unit 1050, and a camera 1060. Also, the game machine 1000 may be coupled to the NFC reader 1100. Here, the NFC reader 1100 may be installed in the game machine 1000 in a built-in or external form. In an exemplary embodiment of the present disclosure, the NFC reader 1100 and the NFC terminal device 1400 may employ any of the various short-range communication schemes such as the BLE and RFID.

The boarding fuselage 1010 enables the user to board the game machine 1000 and is physically driven in a state that the user is boarding. The boarding fuselage 1010 includes at least one boarding unit allowing the user to board the game machine 1000 and safely fixing a part of the user, at least one actuator for changing the position and/or direction of the boarding unit in a predetermined direction, and a manipulation unit allowing the user to manipulate the game execution. The boarding fuselage 1010 may undergo motions such as a displacement or a rotation according to the manipulation of the user and under the control of the controller 1020 for the proceeding of the game operation.

The controller 1020 controls the operation and the state of the game machine 1000. The controller 1020 loads and executes a game program and controls the boarding fuselage 1010 according to the algorithm of the executed program to provide a simulated environment. In addition, the controller 1020 controls the HMD unit 1030 to output pictures generated during the execution of the game program, collects game information, and collects the reaction information of the user (e.g. video information or audio information of the user).

After the user having boarded the game machine 1000 is detected by the NFC reader 1100, the controller 1020 collects the information on a type of the game, a difficulty level set by the user, and the like when the user selects or initiates a game. Also, the controller 1020 collects the game execution data as the progress of the game. The controller 1020 may further collect information about the mission accomplishment after the completion of the game.

The controller 1020 may transmit the collected game execution data to the server device 1200 together with the identification information of the NFC terminal device 1400 read out by NFC reader 1100 during the execution of the game or after completion of the game.

The communication unit 1040 establishes a communication channel of the game machine 1000 and transmits and receives data to and from an external device. For example, the communication unit 1040 may establish a communication channel with the server device 1200 to provide the server device 1200, under the control of the controller 1020, with information such as the identification information of the user, a game usage fee including a usage of a free pass, a coupon, and a fee package, the game execution data (e.g. the type of game, the difficulty level set by the user, performance ability of the user, a game usage history of the use), and a mission applicable by the use that the information, and the like to the server device 1200 under the control of the controller 1020. The communication device 1010 may include at least one of a wired communication device or a wireless communication device capable of forming a wireless communication channel.

The HMD unit 1030 is mounted on at least a part of the user's head or at least a part of the user's face to provide a VR image to the user. The HMD unit 1030 may output the VR image related to the game execution under the control of the controller 1020.

The audio unit 1050 may include at least one speaker capable of outputting audio sound required for the operation of the game machine 1000 and at least one microphone capable of receiving the voice of the user. The audio unit 1050 can output narrations required for the game operation, various sound effects, and explanatory information necessary for the game operation under to the control of the controller 1020. Also, the audio unit 1050 may collect the voice of the user during the execution of the game and may transmit the collected user voice to the server device 1200 via the communication device 1010 under the control of the controller 1020.

The camera 1060 may be disposed on one side of the game machine 1000 to capture images of a part of the user body including the face. The camera 1060 acquires the images periodically or in real time while the user is boarding the game machine 1000 and executing the game, and transmits the images of the user to the system 1200 via the communication device 1010 in accordance with the control of the controller 1020. The images captured by the camera 1060 include shots for a cheer, a screaming, and a fright of the game user in the game machine 1000, which may attract attention of the people around the game machine and can be used for face recognition, gesture recognition, motion recognition, and the like.

The controller 1020 analyzes video information acquired by the camera 1060 and audio information collected by the audio unit 1050 to estimate the reaction of the user and calculates the reaction point according to the analysis result.

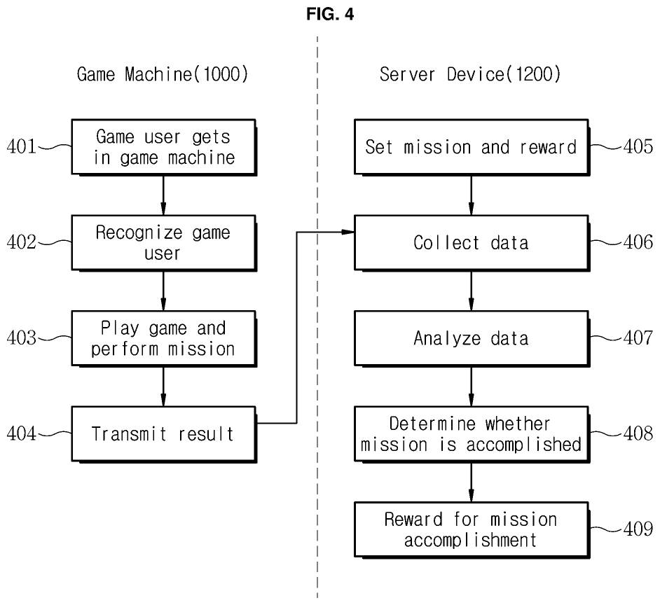

FIG. 4 is a flowchart illustrating a process of intelligently rewarding for the mission accomplishment according to an embodiment of the present disclosure.

The operation of the intelligent rewarding system according to an embodiment of the present disclosure will now be described with reference to FIGS. 2 and 4.

If a game user boards the game machine 1000 according to the present disclosure in operation 401, the game machine 1000 recognizes the NFC terminal device 1400 held or worn by the game user through the NFC reader 1100 and extracts the unique identification information from the NFC terminal device 1400 in operation 402. That is, the game machine 1000 identifies the game user by recognizing the identification information extracted from the NFC terminal device 1400 as the user identification information. In an exemplary embodiment of the present disclosure, the NFC reader 1100 and the NFC terminal device 1400 may employ any of the various short-range communication schemes such as the BLE and RFID.

After the user recognition is completed, the game machine 1000 executes a game according to the manipulation of the game user and/or a predetermined game algorithm in operation 403, and the user performs a predetermined mission by playing the game. At this time, in another embodiment of the present disclosure, the game machine 1000 may provide the game user with the information about one or more predetermined missions and resultant rewards, so that the game user can choose and perform a desired mission.

After the game is terminated, the game machine 1000 transmits the game execution data to the server device 1200 as a result of the game of the user in operation 404. The operation 404 may be performed periodically during the game execution or after the game is terminated. When transmitting the game execution data, the game machine 1000 may transmit the identification information read out from the NFC terminal device 1400 as the identification information of the user together with the game execution data.

On the other hand, in operation 405, the server device 1200 sets the mission to be accomplished by the game user regarding the game machine 1000 and the reward to be provided when the game user succeeds in the mission accomplishment before the user initiates the game. At this time, the server device 1200 may transmit a message containing information of the mission and the reward to the mobile terminal devices 1300 of potential game users who may use the game machine 1200 to arouse the concern and interest of the potential game users. This can be done automatically when a user enters the store, or in response to a command of the store administrator or according to a setting designated by the program or the store administrator, but may be omitted in some cases. In addition, when providing the mission and reward information, the server device 1200 may further transmit the advice information extracted from the analysis of the past game execution data of the user.

Also, in operation 405, the server device 1200 may set the mission and the reward for the mission accomplishment differently for each game user. In detail, the server device 1200 may analyze at least one of: the tendency, the preference, and the capability of the user based on the past game execution data of the game user, and may set the mission and the reward for the mission accomplishment for each game user based on the extracted personal characteristics data. Further, the game user may be allowed to set the mission and the reward for the mission accomplishment for oneself in consideration of the personal characteristics data such as the tendency, the preference, and the capability of the user.

In operation 406, the server device 1200 collects the game execution data related to the game executed by the game user having boarded the game machine 1000. The operation 406 may be performed repetitively in a predetermined period during the execution of the game or after the game is terminated. In case that the mission and the reward for the mission accomplishment are set to be customized for each game user, the game execution data may be collected independently for each game user for whom the mission and the reward are set in the customized manner. To this end, in the operation 406, the server device 1200 may identify the game user corresponding to the collected game execution data and check whether the mission and the reward are set for the identified game user. Here, the identification of the user may be performed based on the identification information read out from the NFC terminal device 1400 held or worn by the game user and the identification information of the mobile terminal device 1300 matched thereto.

Next, the server device 1200 analyzes the collected game execution data in operation 407, and determines a mission performance result of the game user, that is, whether the game use succeeded in the mission accomplishment in operation 408 based on an analysis result. In particular, more than one missions may be set in the present disclosure. When the server device 1200 receives the game execution data, the server device 1200 compares the game execution data with the preset mission to check whether the mission is accomplished.

In operation 409, the server device 1200 may check the reward to be provided to the game user having accomplished the mission and provide the reward to the game user. The rewarding may be carried out based on the information on the mission and the rewarding which is set previously. Here, the rewarding may be provided in various forms such as a game voucher, a coupon, a discount voucher, a point, and a prize.

In the operation 409, the server device 1200 may transmit a rewarding notification message including mission success and compensation information to the mobile terminal device 1300 of the game user through the communications network to notify the mission accomplishment and the reward for the accomplishment. To this end, the server device 1200 may maintain the identification information of the NFC terminal device 1400 held or worn by the game user and the identification information of the mobile terminal device 1300 matching the identification information of the NFC terminal device 1400.

As described above, the present disclosure can increase the concern and interest of the game users for the game machine and induce the use of the game machine by providing the game users with the information on the mission and the reward for the mission accomplishment, determining the success or failure of the mission based on the game execution data of the users having used the game machine, and transmitting the reward notification message to the mobile terminal device 1300.

Apart from the above-described process, the server device 1200 according to the present disclosure may be configured to analyze the game usage history of the users for a plurality of game machines 1000, the frequency of the usage, the response of the users to the plurality of games, the interest of the users for the plurality of games, and the learning level of the users by using a reinforcement learning algorithms of the artificial intelligence based on past game execution data accumulated for a certain time. Through such an analysis, the server device 1200 may extract missions and the reward appropriate to the store or gaming room, or may extract the mission having a suitable difficulty level and customized for each user.

The server device 1200 can provide the store administrator with the extracted information as recommendation information, thereby supporting the administrator in setting the mission and the reward.

The present disclosure supports the operation of the gaming room or gaming store in which at least one game machine such as the virtual reality game is installed by assigning the mission to be accomplished by the gamer and rewarding for the mission accomplishment, and thus may enhance the use of the game machine and allow the owner of the gaming room to operate the gaming room efficiently.

In particular, the present disclosure identifies the user boarding the game machine by NFC terminal device held or worn by the user and having the shape of a card or a wearable device and collects and analyzes game performance data of the user to determine whether the user accomplished the mission and is to be rewarded. The present disclosure stores the identification information acquired from the terminal device of the user along with the identification information of the mobile terminal of the user to notify rewarding information to the mobile terminal of the user.

Logical blocks, modules or units described in connection with embodiments disclosed herein can be implemented or performed by a computing device having at least one processor, at least one memory and at least one communication interface. The elements of a method, process, or algorithm described in connection with embodiments disclosed herein can be embodied directly in hardware, in a software module executed by at least one processor, or in a combination of the two. Computer-executable instructions for implementing a method, process, or algorithm described in connection with embodiments disclosed herein can be stored in a non-transitory computer readable storage medium.

In addition, the present disclosure analyzes the past game execution data of the user to provide advisory information related to the mission accomplishment, thereby attracting the concern and interest of the user and enhancing the use of the game machine.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for rewarding a user of a game machine, the system comprising:
a mission and reward setting unit configured to set a mission and a reward to be presented to a user using the game machine;
a user identifying unit configured to identify the user boarding the game machine;
a data collecting unit configured to collect game execution data of the user identified by user identifying unit;
a data analyzing unit configured to analyze the game execution data collected from the game machine to determine whether the user succeeded in the mission accomplishment; and
a rewarding unit configured to provide the reward set by the mission and reward setting unit when the user succeeded in the mission accomplishment.

2. The system as claimed in claim 1, wherein the data analyzing unit is configured to analyze past game execution data of the user and configured to extract advice information related to the mission accomplishment to provide to the user.

3. The system as claimed in claim 1, wherein the mission is set as a mission item and a target value for the mission item, and
wherein the mission item includes at least one of: a reaction point that measures a response of the user during a play of a game, a game score obtained according to a fulfillment of the game, or a game lap time.

4. The system as claimed in claim 3, wherein the reaction point is calculated according to at least one of a facial analysis result or a motion analysis result based on images captured by a camera, or a voice analysis result for the voice of the user acquired by an audio device while the user is playing in the game machine corresponding to the game.

5. The system as claimed in claim 1, wherein the mission and reward setting unit is configured to set the mission and the reward for each of the at least one game machine, for each item, or for a combination of two or more game machines.

6. The system as claimed in claim 1, wherein the data analyzing unit is configured to analyze at least one of a tendency, a preference, and a capability of the user based on past game execution data of the user, and
wherein the mission and reward setting unit is configured to set the mission and the reward for the mission accomplishment for each user based on an analysis result of the data analyzing unit.

7. The system as claimed in claim 1, wherein the user identifying unit is configured to recognize a short-range terminal device held by the user by use of a short-range communication reader mounted in the game machine and further configured to identify the user by matching unique identification information of the short-range terminal device with identification information of a mobile terminal device of the user.

8. The system as claimed in claim 1, wherein the rewarding unit is configured to transmit rewarding information corresponding to the mission accomplishment to a mobile terminal device of the identified user.

9. A method of rewarding for a mission accomplishment in a place of business, in which at least one game machine is installed, performed by a computing apparatus connected to the at least one game machine, the method comprising:
setting a mission and a reward to be presented to a user using the game machine;
identifying the user boarding the game machine;
collecting game execution data of the user identified by user identifying unit;
analyzing the game execution data collected from the game machine to determine whether the user succeeded in the mission accomplishment; and
providing the reward set for the mission accomplishment when the user succeeded in the mission accomplishment.

10. The method as claimed in claim 9, further comprising:
transmitting information on the mission and the reward for the mission accomplishment, in advance, to a mobile terminal device of the user of which terminal is registered being matched with a short-range communication terminal of an identified user or to a mobile terminal device of a subscribed user.

11. The method as claimed in claim 9, wherein the setting the mission and the reward comprises:
analyzing at least one of a tendency, a preference, and a capability of the user based on past game execution data of the user; and
setting the mission and the reward for the mission accomplishment for each user based on an analysis result of the tendency, the preference, and the capability of the user.
